(19) United States
(12) Patent Application Publication
(10) Pub. No.: US 2006/0211410 A1
(43) Pub. Date: Sep. 21, 2006

(54) Portable wireless communication device

(75) Inventors: Jean-Christophe Deniau, Fenton, MI (US); Neil Garbacik, Rochester Hills, MI (US); Mohamed Tiba, Dearborn, MI (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens VDO Automotive Corporation, Auburn Hills, MI (US)

(21) Appl. No.: 11/358,346

(22) Filed: Feb. 21, 2006

Related U.S. Application Data
(60) Provisional application No. 60/663,519, filed on Mar. 18, 2005.
(60) Provisional application No. 60/663,520, filed on Mar. 18, 2005.
(60) Provisional application No. 60/663,522, filed on Mar. 18, 2005.
(60) Provisional application No. 60/665,425, filed on Mar. 24, 2005.

(51) Int. Cl. H04Q 7/22

(52) U.S. Cl. 455/412.1

(57) ABSTRACT

An exemplary wireless communication device includes a command area and a display area. The command area transmits wireless communications and the display area displays information. The wireless communication device provides the capability to make payments, and includes the capability to save information relating to songs for recall and purchase.

### REFERENCE TO RELATED APPLICATIONS

The application claims priority to U.S. Provisional application Ser. Nos. 60/663,519, 60/663,520, 60/663,522 and 60/665,425 which were filed on Mar. 18, 2005.

### BACKGROUND OF THE INVENTION

The present invention relates to a wireless communication device, more specifically, the present invention relates to a device capable of wireless control of a multitude of functions within a single wireless communication device.

The popularity of wireless devices has grown rapidly in recent years due in part to the increasing portability of the wireless devices. As portability increases, so too does the number of wireless devices available and the number of wireless devices possible for any one person to carry. Accordingly, a technologically savvy person in today's society may carry a variety of wireless devices at a time, each of which is capable of performing at least one specific and distinct function. When a particular function is desired, the operator must locate the appropriate wireless device for performing the desired function. As a result, a portion of the time saved by using the wireless device is lost because of time spent locating the appropriate wireless device

An operator utilizes wireless devices in many day-to-day activities. For example, the operator may utilize a wireless device, such as a remote-starter, to turn on a vehicle during inclement weather. The remote-starter starts the vehicle, but does not provide feedback relating to the status of the vehicle.

In another example, the operator may carry another separate wireless device that enables activation of a fuel pump when the device enters a certain area, e.g., when the device is moved near the fuel pump at a service station. The device wirelessly communicates with the fuel pump and credits the fuel purchase to the operator's credit card.

Disadvantageously, using multiple wireless devices requires that the operator track the devices and have the wherewithal to maintain control over all of the wireless devices. It would be beneficial to combine the functions of multiple wireless devices into a single unit.

Accordingly, it is desirable to provide a wireless device capable of a multitude of functions, thereby reducing the total number of devices an operator is required to maintain control over. It is further desirable to combine wireless functions into a wireless device, which is easily transported.

### SUMMARY OF THE INVENTION

A wristwatch, a type of wireless device, includes a command area and a display area. The command area transmits wireless communications, and the display area displays the current time and information relating to the status of the vehicle.

The wristwatch issues a multitude of wireless commands, such as a command to a vehicle to unlock the vehicle door or a command that controls a climate control system of the vehicle. The command area of the wristwatch includes push buttons used to wirelessly control various vehicle functions. A transmitter within the vehicle transmits vehicle status information to the wristwatch for display on the display area of the wristwatch. Because the display area communicates wireless communications from the vehicle, a user observing the display area receives continual updates relating to the status of the vehicle. The operator may select which information is displayed with the command area if additional information is desired.

In another example, the wireless device is a phone that provides for wireless payments. The phone may be used to wirelessly pay tolls or pay for fuel at suitably equipped service stations. If the operator wishes to access additional funds, the operator may call the service provider who then credits the appropriate account or otherwise makes additional funds available. The operator may also deactivate the phone or the payment portion of the phone by placing a call to the service provider.

The phone may also save information, such as information that identifies songs or other types of radio broadcasts. A song playing over a vehicle radio contains encoded information to identify the song. For example, digital broadcasts will contain a digital watermark. The phone contains a save/buy feature that the operator may activate upon hearing a song, or other type of broadcast, that they desire to own or recall at a later time. The phone receives and saves the digital watermark identifying the song. The digital watermark enables the user to identify and recall the song at a later time for purchase. The operator may recall the web addresses for saved songs using the wireless device.

These and other features of the present invention can be best understood from the following specification and drawings, the following of which is a brief description.

### BRIEF DESCRIPTION OF THE DRAWINGS

FIG. 1 schematically illustrates the wireless communications between a wristwatch and a vehicle.

FIG. 2 is a schematic view of a wristwatch for monitoring vehicle status.

FIG. 3 is a schematic view of a phone including a payment capability.

FIG. 4 is a schematic view of a method for saving information on the phone.

FIG. 5 is a schematic view of a method of recalling information saved on the phone.

### DETAILED DESCRIPTION OF THE PREFERRED EMBODIMENT

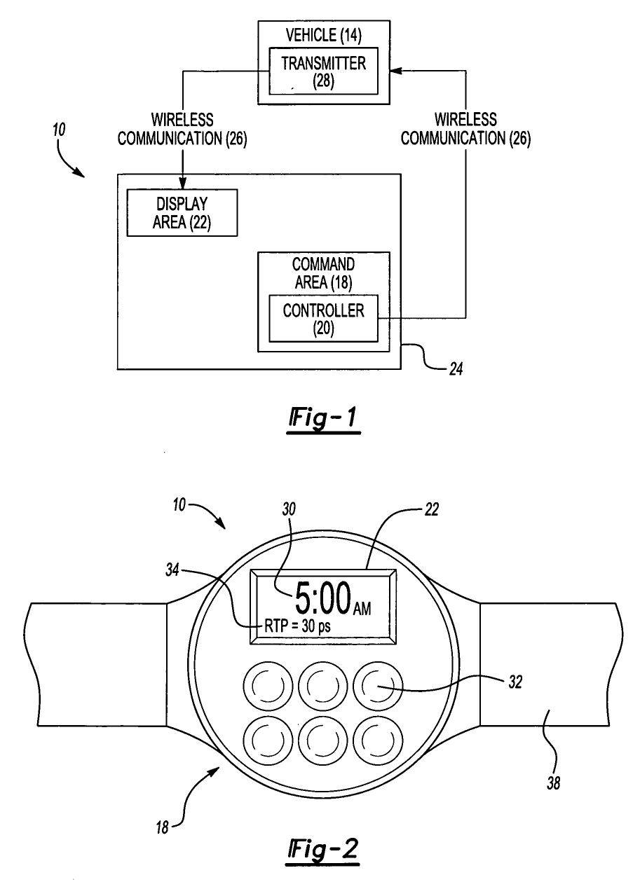

FIG. 1 schematically illustrates a wristwatch 10 for communicating with a vehicle 14. The wristwatch 10 includes a command area 18 and a display area 22 both at least partially disposed within a protective housing 24. In one example, a wireless communication 26 from the wristwatch 10 unlocks the doors of the vehicle 14. In another example, the wireless communication 26 controls a climate control system of the vehicle 14 to obtain and maintain a desired temperature inside the vehicle 14.

The command area of the wristwatch 10 includes a controller 20 for generating the wireless communication 26. The wireless communication 26 may include signals from different portions of the electromagnetic spectrum. For example, the controller 20 may generate Radio Frequency communications to obtain and maintain a desired temperature inside the vehicle 14, while the controller 20 generates a Low Frequency communication to unlock the doors of the vehicle 14.

After receiving the wireless communication 26, a transmitter 28 within the vehicle 14 wirelessly transmits information back to the wristwatch 10. The information is then displayed on the display area 22 of the wristwatch 10. The display area is an LCD screen on the wristwatch 10. If the wireless communication 26 commands the vehicle 14 to heat to a desired temperature, the wireless communication 26 from the vehicle 14 to the display area 22 will communicate that the desired temperature has been achieved. Alternatively, the vehicle 14 communicates incremental temperature increases to the display area 22, such that an operator may monitor the increasing temperature in the vehicle 14.

Further detail relating to the command area 18 and display area 22 are shown in the detailed illustration of the wristwatch 10 in FIG. 2. As shown, the command area 18 includes one or more push buttons 32, which are used to initiate the control of the various vehicle 14 functions. The display area 22 of the wristwatch 10 includes information obtained from wireless communications 26 with the vehicle 14. In this example, the display area 22 includes a display of the current time 30 as well as a display of Rear Tire Pressure (RTP) 34 of the vehicle.

The wristwatch includes a strap 38, which operates to secure the wristwatch 10 to the user. The design of the strap 38 enables the user to wear the wristwatch 10 around their wrist.

Because the transmitter 28 within the vehicle 14 communicates wirelessly with the wristwatch 10, the user may receive continual updates relating to the status of the vehicle 14. If the user desires additional information, the user may actuate the pushbuttons 32 within the command area 18 of the wristwatch 10.

For example, if the user wishes to observe the current temperature of the inside of the vehicle 14, the user presses the pushbuttons 32 to modify the display area 22 to include the temperature information. Actuating the pushbutton 32 forces the controller 20 to send wireless communications 26 to the vehicle 14, which prompts the transmitter to relay the current temperature to the display area 22 of the wristwatch 10. Alternatively, the transmitter 28 may continually update the wristwatch 10 with the temperature of the vehicle 14, without requiring prompting from the controller 20.

Although described in terms of vehicular commands, those skilled in the art and having the benefit of this disclosure will understand that the commands from the wristwatch 10, or other type of wireless device, may control a variety of items, such as opening and closing entry gates, or activating lights of a user's home. In addition to these and other functions, the wristwatch 10 may also communicate wireless payments.

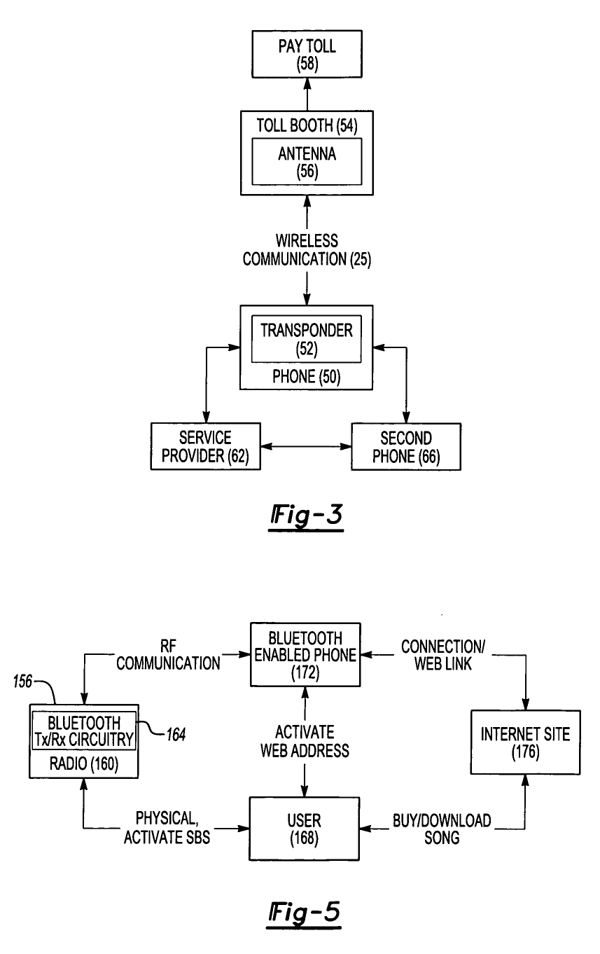

The schematic illustration of FIG. 3 depicts a phone 50, another type of wireless device, for making a toll payment 58. The phone 50 forms a portion of a cellular network enabling the user to place calls from the phone 50 to other phones within the cellular network.

The phone 50 includes a transponder 52, which is activated when in the vicinity of an antenna 56, such as the antenna 56 in a toll booth 54, emitting a wireless communication 25 at an appropriate strength and frequency. Once activated, the transponder 52 within the phone 50 wirelessly communicates information back to the toll booth 54 via the transponder 52 and the antenna 56. In this example, the information communicated to the toll booth 54 identifies the user of the phone 50, and provides authorization to pay the toll 58.

The phone 50 may include access to an account with a limited amount of funds available to pay the toll 58. If the user wishes to add additional funds, they may place a call from the phone 50 to a phone service provider 62, who then credits the appropriate account and makes additional funds available in a known manner.

Accordingly, a user possessing the exemplary phone 50 may wirelessly pay tolls 58 without relying on a second wireless device, and can increase the amount of available funds by communicating with the service provider 62. Similarly, the user may utilize the phone 50 to pay for fuel or other items at suitably equipped service stations. Because the phone 50 includes the transponder 52 to communicate information, such as a payment, there is no need for the user to carry a separate wireless device to make these payments.

In the event the phone 50 is stolen or lost, the user can deactivate the pay toll 58 function of the phone 50. To do so, the user places contacts the service provider 62 and requests deactivation of phone 50. A second phone 66, or email or other communication methods can be utilized to contact the service provider 62. Deactivation may be accomplished by entering an alphanumeric code or by speaking directly to an operator. The user may also add funds to the phone 50 utilizing the second phone 66 to contact the service provider 62. Alternatively, the user may contact the service provider 62 via email.

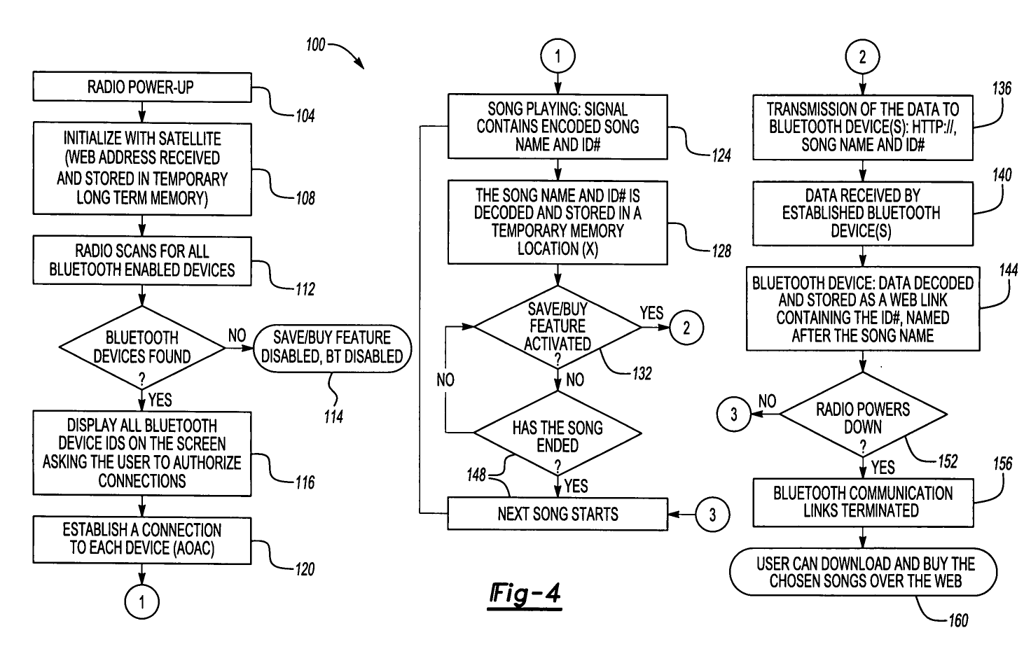

In addition to payments and commands, it is desirable to include other functions within the phone 50, such as the ability to save information. An exemplary method 100 of saving information on the phone 50, or similar wireless device, is shown in FIG. 4.

Referring to step block 104, a radio within a vehicle powers up and initializes with a satellite, as shown in step block 108. Once initialized, the radio is capable of receiving satellite radio broadcasts, such as songs or other satellite programming. After initializing with the satellite, the radio then scans for available wireless devices 112 within the vicinity of the radio. Preferably the radio communicates to the available wireless devices utilizing Bluetooth technology, or similar type wireless communication.

If the radio fails to locate any available devices, the method 100 disables the song-saving feature as shown in step block 114. If a Bluetooth enabled device is found, the radio displays the device on a radio command screen 116 and prompts the user to establish an AOAC (Always On/Always Connected) type of connection 120 between the phone 50 and the radio. That is, before proceeding, the radio display menu will visually prompt the user to accept the wireless connection between the radio and the device. Preferably, the user must press a button on the phone 50 or the radio acknowledging that they wish to establish a connection.

As shown in step block 124, broadcasts over the vehicle radio contain encoded information identifying the song. For example, a digital song broadcast may contain an encoded name or identification number that may be retrieved and temporarily stored within the radio, as in step block 128. The identification is ordinarily included as a digital watermark within the song. When the operator hears a song that they desire to own or recall at a later time, the user activates a save/buy button on the phone 50 or the radio interface, as shown in decision block 132. When the save/buy button is activated, the phone 50 receives and records the digital watermark as indicated 140 that identifys the song. Saving the digital watermark on the phone 50 enables the user to recall the song and store the information in an appropriate form, such as a web link 144. If the operator chooses not to activate the save/buy feature the digital watermark is not recorded.

Powering down the radio 152 terminates the links to the phone 50. However, if the save/buy feature was activated, the phone 50 will have retained information about the previously saved song. The operator may then recall the information at a later time and purchase the song if they so desire.

FIG. 5 further details the wireless interactions of saving information on the phone 50. Step block 156 illustrates a vehicle radio 160 having Bluetooth circuitry 164 for communicating with a Bluetooth enabled phone 172. A user 168 activates the save/buy feature when they desire to save radio broadcasts to their Bluetooth enabled phone 172. The saved information is typically in the form of a digital watermark, which may correspond to an internet site 176 or may only contain information about the broadcast, such as an artist and song title.

In addition to wirelessly communicating with the radio 160, the wireless device also communicates with an internet site 176. The wireless device 172 may accomplish this communication wirelessly or, for example, utilizing a docking station. The user 168 activates the appropriate website for their saved songs and then may review or buy the songs utilizing the internet site 176.

Although broadly described in terms of recalling information relating to a song and recalling that information to purchase the song, those skilled in the art and having the benefit of this disclosure will be able to comprehend other suitable applications. For example, an operator hearing a portion of a talk-show program, and wishing to listen to the remainder, may activate the save-buy feature of their Bluetooth enabled phone 172. The operator may then recall the title of the program at a later time, as well as additional information about the program. If available, the operator may download a recorded version of the program. The operator may allocate time to listen to additional broadcasts of the program in the future.

Although a preferred embodiment of this invention has been disclosed, a worker of ordinary skill in this art might recognize that certain modifications are possible that come within the scope of this invention. For that reason, the following claims should be studied to determine the true scope of protection given for this invention.

What is claimed is:

1. A portable wireless device for controlling a vehicle function, comprising:
a vehicle command portion operative to generate a wireless command which controls a function of a vehicle; and
a display portion having a screen for displaying information about the vehicle, and for displaying a time of day.

2. The portable wireless device as recited in claim 1, wherein said wireless commands are radio frequency commands.

3. The portable wireless device as recited in claim 1, wherein said wireless commands are low frequency commands.

4. The portable wireless device as recited in claim 3, wherein said low frequency commands actuate a vehicle lock.

5. The portable wireless device as recited in claim 1, wherein said command portion and said display portion are disposed within a housing adapted to be worn by an operator.

6. The portable wireless device as recited in claim 5, wherein said housing comprises a wristwatch.

7. A cellular phone, comprising:
a communication portion providing communication with a cellular network; and
a command portion for transmitting command signals for remotely controlling an access function to at least one secured area, wherein said command portion is selectively enabled from a remotely located device.

8. The cellular phone as recited in claim 7, including contacting a provider of said cellular network to remotely disable said command portion.

9. The cellular phone as recited in claim 8, wherein said provider is contacted via phone.

10. The cellular phone as recited in claim 8, wherein said command portion is remotely disabled by communicating an alphanumeric code to said provider.

11. The cellular phone as recited in claim 8, wherein said provider is contacted via electronic mail.

12. The cellular phone as recited in claim 8, wherein said command portion is remotely disabled by communicating an alphanumeric code to said provider.

13. The cellular phone as recited in claim 7, wherein said at least one secured area includes a vehicle.

14. The cellular phone as recited in claim 7, wherein said at least one secured area includes a residence.

15. The cellular phone as recited in claim 7, including a transponder activated response to a signal from the remotely located device.

16. A cellular phone, comprising:
a communication portion providing communication with a cellular network; and
a transponder operative to communicate an authorization for a wireless payment, wherein said transponder may be remotely disabled.

17. The cellular phone as recited in claim 16, wherein said wireless payment comprises an authorization to activate a fuel pump.

18. The cellular phone as recited in claim 16, wherein said wireless payment comprises an authorization to credit funds to pay a toll.

19. The cellular phone as recited in claim 16, wherein contacting a provider of said phone communication may disable said transponder.

20. The cellular phone as recited in claim 16, including a monetary limit on said wireless payment, wherein contacting a provider of said phone communication may increase or decrease said monetary limit.

21. A method of saving information on a wireless device, comprising:
a) encoding a radio broadcast with an identification marker;
b) establishing a connection between a wireless device and a radio;
c) storing the identification marker on the wireless device; and
d) recalling the identification marker on the wireless device.

22. The method as recited in claim 21 including the step of:
e) accessing information relating to the radio broadcast based on the identification marker.

23. The method as recited in claim 21 including the step of:
e) purchasing a recording of the radio broadcast.

24. The method as recited in claim 20, wherein said step a) includes encoding a song with an identification marker.

25. The method as recited in claim 23, including the step of:
e) purchasing a recording of the song.
